(19) United States
(12) Patent Application Publication
(10) Pub. No.: US 2005/0223112 A1
(43) Pub. Date: Oct. 6, 2005

(54) System and method for data routing

(76) Inventors: Egidius Van Doren, Eindhoven (NL); Hendrikus Van Heesch, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/521,855

(22) PCT Filed: Jun. 25, 2003
(86) PCT No.: PCT/IB03/02845

§ 371 Date: Jan. 21, 2005

(30) Foreign Application Priority Data
Jul. 25, 2002 (EP) 02078040.9

(51) Int. Cl. G06F 15/173

(52) U.S. Cl. 709/238

(57) ABSTRACT

This invention relates to a method of dynamically allocating processing resources in a processing network comprising nodes for processing data in a data stream by the usage of attaching end markers to maintain a relative ordering among packets the follow different routes in the network. By means of route reservation deadlock situations between two routes are thereby eliminated. When a node receives a route marker (R1), the marker is interpreted and re-routing is accomplished. When the node receives a next marker (R2), the node inserts an end marker (E1) into the stream and interprets the next marker (R2) as previously noted.

This invention relates to processing networks and more particularly to a system and a method for routing data through multiple nodes in said network.

A processing network graph representation typically comprises a number of processing nodes that establishes an asynchronous data flow for data to pass through for processing. The graph may provide a structure for processing nodes so that different sources are effectively mixed and routed to a variety of data output devices.

For various applications the network graph is often used to stream data at the software layer. Software streaming may be represented by a graph of processing nodes where the communication between the nodes is done using discreet packets of data and typically based on a number of components located in the graph structure where the nodes may represent the processing steps that perform activities to e.g. parse, decode and process streams of data so that it for example becomes output for a output device. Nodes actively transport packets from their input edges to their output edges, making the data flow through the graph. Each packet follows a certain route through the graph, starting at a source node and ending at a sink node. Data is said to be streaming through a graph, since a data sequence, a data segment, etc. comprising data packets is typically already arriving at a sink node before all data is produced at the source node.

Traditionally, the connections between nodes are static, i.e. they never change while data is streaming. However, to fully exploit the flexibility of programmable DSP processors it may be advantageous to change a graph while streaming. Reasons to change a graph include certain mode changes in the application controlling the streaming graph representation that require a route via different processing nodes for subsequent packets.

Before the streaming graph can change, data that is already within the streaming graph must be flushed or the existing data in streaming graph must be processed. Reconfiguring a graph without loosing data is only possible if data in the old route has the possibility to stream out of the graph. However, it is in general not possible to keep the old route intact while constructing the new route, since these routes may require the same resources. Furthermore, if two subsequent packets originating from the same source have followed two different routes, due to a dynamic change, their relative order may become disarranged at the destination node.

Additionally, if two routes have more than 1 node in common that are visited in a different order, deadlock may occur if for instance the first route has claimed the first node and the second route has claimed the second node, and after that both routes want to claim the other node.

Changing a streaming graph without pausing the stream until the preceding data has been processed may be advantageous for many applications. It is therefore an object of the present invention to solve the above-mentioned problem of changing a graph when the data stream properties changes while still maintaining the relative order of packets at the destination node.

Furthermore, it is an object of the present invention to prevent deadlocks that may occur if two routes share more than one node in a very simple fashion.

This is achieved by a method (and corresponding system) of dynamically routing of data through a processing network, comprising at least three nodes for receiving, processing, and transmitting of data, the method comprising the steps of defining a linear route through a number of said nodes, a first node being a source of the route; reserving connections for the route that originates at the source node by storing route reservation information associating the defined nodes and/or reserved connections of the route with a time of reservation; transmitting a start marker for the route at the source node before any data for the route is sent from the node; establishing a connection between the first node and the next node on the route and removing the reservation information for the two nodes and if the first node is about to send the start marker to the next node, the next node is not already connected to any upstream node, and the reservation information of the next node indicates it should connect to the first node; disconnecting a connection between the first node and the next node if the next node has received an end of route marker from the first node, and the next node is connected to the first node; forwarding any end marker, start markers and data downstream over the connection; transmitting data for each node to the next node connected on the route; and creating and transmitting an end marker at a source node when subsequent data has to travel via another route.

A route is to be defined to be linear, that is, the same route should only visit each node once. Furthermore, a route is single path, i.e. no tree structures and sub-routes are allowed. However, the route itself may be defined as a subpath within a total path.

To maintain the relative ordering of data packets, markers are to be sent along the data stream. A marker is a piece of information, e.g. a number, and can be implemented as a special packet in the stream, some special data field in a regular data packet, etc. To be able to know which route a stream of data should follow, a first start marker and a second end marker is inserted at the source node, to define the start and end of the current stream. In this embodiment all data streams should be wrapped with a start and end marker. The first packet after an end marker should always comprise a start marker. Otherwise the route of the data stream following the end marker would be undefined.

Using the solution detailed in the following, a convenient and high-level interface for dynamically routing packets through a streaming graph can be offered to the application controlling the graph. Low-level ordering and synchronisation details are hidden from the application by offering the high-level concept of a route.

Preferred embodiments are defined in the sub-claims.

The invention will be explained more fully below in connection with preferred embodiments and with reference to the drawings, in which:

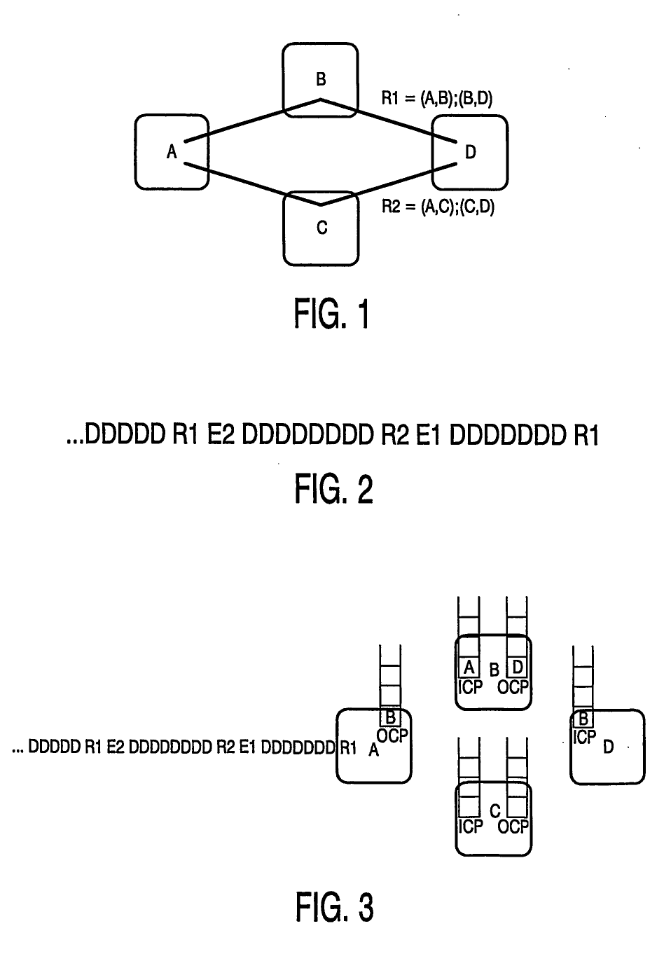

FIG. 1 illustrates two routes in a graph of four nodes;

FIG. 2 illustrates data streams separates by start and end markers;

FIG. 3 illustrates a reservation of a route;

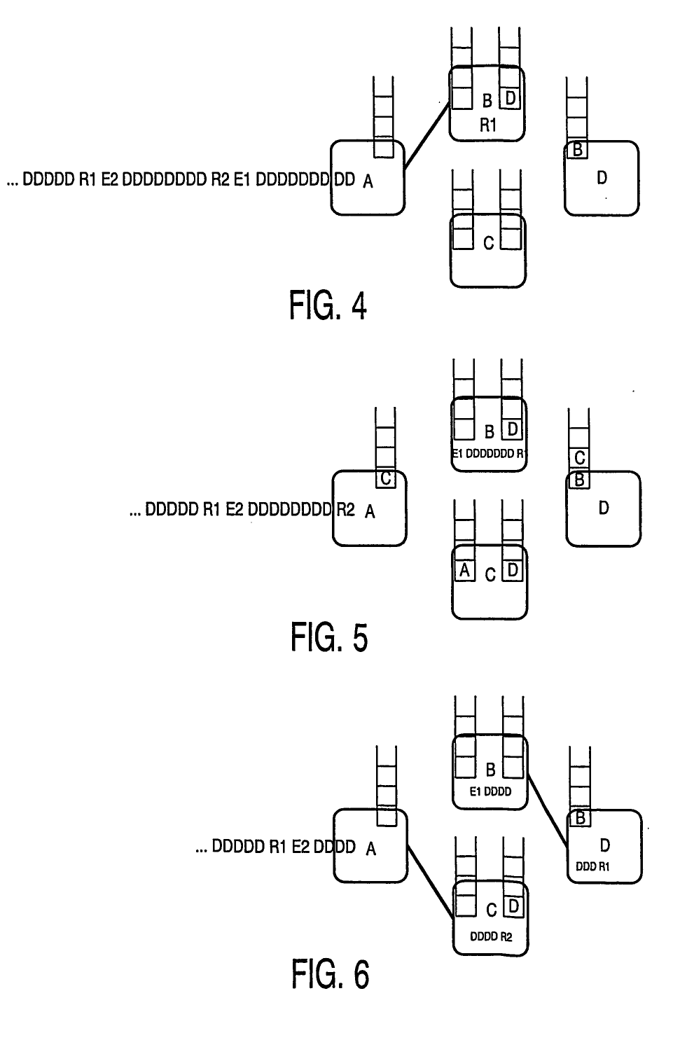

FIG. 4 illustrates a first connection for a route;

FIG. 5 illustrates the connection of FIG. 4 disconnected and a reservation for a second route;

FIG. 6 illustrates a second connection of the route of FIG. 3 and a first connection of the second route;

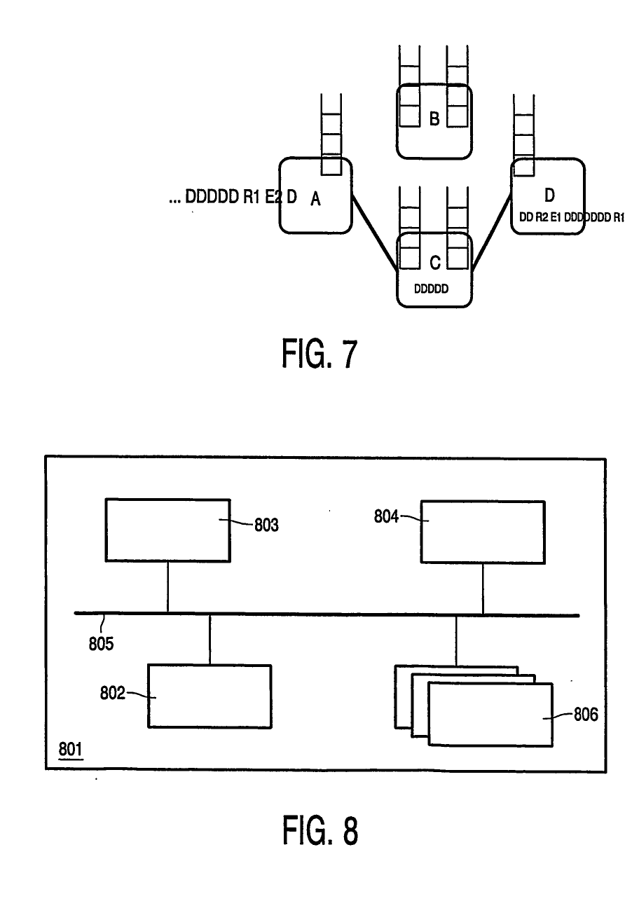

FIG. 7 illustrates a second connection of the second route before the first connection of route 2 is disconnected;

FIG. 8 illustrates a schematic block diagram of a node of the present invention;

Throughout the drawings, the same reference numerals indicate similar or corresponding features, functions, etc.

FIG. 1 depicts an example of a graph representation comprising four nodes (1, 2, 3 and 4) where two routes (R1, R2) are available from the source node (1) to the destination node (4). Either, a data stream must follow a first route (R=(1,2);(2,4)) or a second route (R2=(1,3);(3,4)). The routes (1,2);(2,3);(3,4) and (1,3);(3,2);(2,4) are not relevant for this example.

A route graph may for example be defined among a number of Digital Signal Processors (DSPs), each processor programmed for different dedicated processing tasks such as speech encoding, video processing, etc. The routes of the graph may also be inside a single processor comprising software for a multiple of tasks, wherein routes are defined among different processing functions.

FIG. 2 shows data streams with data packets (D) separated by R- and E-markers to define the start and end of each stream, respectively. In the following, the determination of routes and attaching of markers are done prior to the arrival of the data stream at the first node (1). The determination of routes and attaching of information is done in the source node. The data stream may further only be attached a start marker initially. In this mode, the first node (1) must generate the corresponding end marker to the stream. When a stream without an end marker passes node (1) and a new start marker arrives, the node (1) will generate an end marker and send it along the data stream prior to releasing the connection thereby defining the end of the already sent data stream.

Reservation information is queued in the input connection point (ICP) and output connection points (OCP) of the nodes (see FIG. 3). An expected input edge and matching output edge for each node are stored in FIFO (First In First Out) order in the ICP and OCP, respectively. As seen in FIG. 3, route R1 is reserved, the input connection point of node 2 is reserved to accept connection from node 1 and the output connection point of node 1 is reserved to send to node 2. Likewise node 2 is reserved to send to node 4 which is reserved to receive data from node 2. When data is processed in node 2, the data will be streamed to the node listed in the output connection point of node 2, i.e. node 4 in this example according to the reservation information.

The ordering of packets, for use in synchronisation of the data streams, is determined by the order of reservation. A reservation is done instantaneously in one atomic action for the whole graph so there will be a total ordering between routes and as a result, deadlock due to conflicting routes will never occur. The reservation information must be queued in FIFO order in the ICP/OCP. The first value in the reservation information queue denotes the node to which a node will reconnect first.

When the first data stream with the first start marker noted R1 arrives at the source node 1 the connection to node 2, which is first in the OCP queue, is made and the references 1 and 2 are removed from both queues as illustrated in FIG. 4. When R1 is received at node 2, the data following it are now transmitted to node 2 until an end marker (E1) arrives node 1.

Referring to FIG. 5, all reservations for the second route R2 are made when R2 arrives at node 1. We see that for input of node 4 we have two reservations pending; first the connection of route R1 and thereafter the connection of route R2. The first connection of route R1 is disconnected in FIG. 5 as the second marker E1 arrives at node 1. The marker R2 signals the creation of a connection to node 3, which was expecting to connect to node 1 according to the reservation information in the ICP of node 3. The connection can be made immediately as shown in FIG. 6, as node 3 does not connect to any upstream node.

Note that a reservation is done in one atomic action. The reservation is made when the source node is about to send the new route marker preceding the data.

However, routes may be chosen not to be reserved at the inserting of markers in the data stream. If for some instance, markers are generated and inserted in a stream when it arrives a source node but no reservation is made for this marker, the reservation procedure may be done in the source node. That is, it may be possible to insert the markers and postpone the route reservation until the stream arrives at a source node. This is useful when routes can define subpaths of a total path. That is, as long as each start marker differs from other start markers, the relative ordering can be maintained.

In FIG. 6 data will be sent from node 2 to node 4, as node 4 will accept this connection, due to the queued information. Assuming that R2 arrives at the OCP of node 3 before the data in node 2 is finished being processed, the connection (3,4) will be rejected by node 4, as this connection first will be accepted when the connection from node 2 to node 4 is completed, i.e. connection, transmission, and releasing, owing to the fact that 2 is in front of 3 in the FIFO buffer queue (as shown in FIG. 5). Node 2 will be finished transmitting when E1 is received at node 4. This way, the relative ordering among the streams will be maintained even if the node processes are asynchronous.

Furthermore, if R2 arrives the in OCP of node 3 during transmission of data from node 2 to node 4, the connection from node 3 to node 4 will be blocked, as 4 can not accept any new connections before the current connection is released.

When E1 arrives at the OCP of node 2, the connection (2,4) is released, and the pending connection (3,4) can be made as shown in FIG. 7. In the same figure we see a data stream where the sink node is reached before the total stream has left the source node.

To summarise the characteristics of the above, it can be said that a start marker will always precede the data stream and an end marker will always succeed the data stream. An end marker is used for disconnection and a start marker for reconnection. Just before a route marker is sent by a node, is it known, that the OCP of the node is not connected since an end marker must have ended the preceding stream. The OCP of the node should have at least one reservation to the input of the next node in the determined route since reservation is always executed before the reconnection. Based on whether the ICP of that next node is connected or not, the following action will be performed:
If connected, the reconnection is put on hold and will be resumed after the connection is removed.
If disconnected, it is checked whether the ICP of the next node, at the head of its queue, has a reservation for the current node from which the R-marker originates. If so, the actual connection is made. If not, the reconnection is postponed.

The E-marker will always terminate the data stream. When a node receives an E-marker the connection at the input is disconnected and it is checked whether a connection to another node is pending by checking the queue of the node ICP. If that queue is not empty, a connection with the node at the head of the queue is established.

FIG. 8 shows a schematic illustration of an embodiment of a system (801) comprising the processing node according to a given processing network graph representation, the system comprises one or more microprocessors (802) and/or Digital Signal Processors (806), a storage (803.), and input/output means (804) all connected via a data bus (805). The processor(s) and/or Digital Signal Processor(s) (806) are the interaction mechanism among the storage (803) and the input/output means (804). The input/output means (804) is responsible for communication with the accessible nodes in the processor network, wherein a transport of a data stream and other interaction will occur during operation such as available resource parameters and node capabilities of network nodes. Node parameters can be uploaded from remote nodes via the input/output means (804). This communication between nodes may e.g. be by use of IrDa, Bluetooth, IEEE 802.11, wireless LAN etc. but will also be useful in a wired application solution. The storage (804) stores relevant information like a dedicated computer program or uploaded node parameters for determination of routes, results of optimisation of resource allocation, etc.

The processor means (802) is preferably responsible for said determination of routes, resource allocation optimisation, graph managing and for processing the transmitted data to such an extent as the dedicated software prescribes, etc. Thereby the processor means (802) takes place as a network graph manager which determines the data flow of data streaming through the network graph. The graph manager, i.e. the processor means (802), controls and processes the exchange of streams of data passing from node to node. That is, processor means may be used to manage the activities required to transform data retrieved from the source into output suitable for a receiving node.

Digital Signal Processors may be dedicated programmed for different processing tasks such as speech encoding, video processing, etc. Either, a single multi-issue DSP may comprise several processing means or a multiple of DSPs can be nested to perform processing tasks where each DSP is dedicated fewer processing means than the single multi-issued DSP.

The routes of the graph may also be comprised in a single general-purpose processor comprising software for a multiple of tasks, wherein routes are defined among different processing functions. The uses of general-purpose microprocessors, instead of DSPs, are a viable option in some systems design. Although dedicated DSPs are well suited to handle signal-processing tasks in a system, most designs also require a microprocessor for other processing tasks such as route managing, etc. Integrating system functionality into one processor may be the best way to realize several common design objectives such as lowering the system part count, reducing power consumption, minimizing size, and lowering cost, etc. Reducing the processor count to one also means fewer instruction sets and tool suites to be mastered.

Further, a computer readable medium containing a program for making a processor carry out dynamically allocating processing resources in a processing network according to the preamble that is characterized in the steps of determining a route through a number of network nodes and reserving the number of nodes; attaching a first marker and a second marker to the data stream, the first marker being associated with the route; connecting a first node of the route to a second node of the route, where the second node is stated by way of the associated first marker; transmitting said data stream from the first node to the second node as connection among first and second node is established; and releasing the connection when the second marker arrives the first node is disclosed in the present invention.

A computer readable medium may in this context be a program storage medium i.e. both physical computer ROM and RAM, removable alike non-removable storage drives, magnetic tape, optical disc, digital video disk (DVD), compact disc (CD or CD-ROM), mini-disc, hard disk, floppy disk, smart card, PCMCIA card, information acquired from data networks e.g. a local area network (LAN), a wide area network (WAN), or any combination thereof, e.g. the Internet, an intranet, an extranet, etc.

1. A method of dynamically routing of data through a processing network, comprising at least three nodes for receiving, processing, and transmitting of data, the method comprising the steps of:
defining a linear route through a number of said nodes, a first node being a source of the route;
reserving connections for the route that originates at the source node by storing route reservation information associating the defined nodes and/or reserved connections of the route with a time of reservation;
transmitting a start marker for the route at the source node before any data for the route is sent from the source node;
establishing a connection between the source node and the next node on the route and removing the reservation information for the two nodes and if
a) the source node is about to send the start marker to the next node,
b) the next node is not already connected to any upstream node, and
c) the reservation information of the next node indicates it should connect to the source node;
disconnecting a connection between the source node and the next node if
a) the next node has received an end of route marker from the source node, and
b) the next node is connected to the source node;
forwarding the end marker, start marker and data downstream over the connection;
transmitting data for each node to the next node connected on the route; and
creating and transmitting an end marker at a source node when subsequent data has to travel via another route if no such end marker is already inserted.

2. A method according to claim 1, characterized in that the step of reserving is done as one atomic action for the whole route.

3. A method according to claim 1, characterized in that the reservation information is stored in the nodes on the route in an FIFO queue of a first input connection point (ICP) and in an FIFO queue of a second output connection point (OCP) where a number of node identifiers may be stored in each queue; each identifier representing a neighbouring node to which the node storing the reservation information should be connected to according to the reservation information in the queue.

4. A method according to claim 1, characterized in that said start marker precedes a stream of data and an end marker terminates a stream of data, where this ordering is maintained at all times.

5. A method according to claim 1, characterized in that start and end markers are only inserted in a data stream if properties of the stream change.

6. A method according to claim 1, characterized in that data in a stream may be buffered within a node.

7. A method according to claim 1, characterized in that a, route describes only a segment of the total list of nodes visited by a data stream.

8. A method according to claim 1, characterized in that the next node is designated as the first node and the node succeeding this node according to the route is designated as the next node and the steps of establishing, disconnecting, forwarding, transmitting and designating the first node and the next node are repeated until the end marker of the route has reached its destination node.

9. A system for dynamically routing of data through a processing network, comprising at least three nodes means for receiving, processing, and transmitting of data, the system comprising:
means for defining a linear route through a number of said node means, a first node being a source of the route;
means for reserving connections for the route that originates at the source node by storing route reservation information associating the defined nodes and/or reserved connections of the route with a time of reservation;
means for transmitting a start marker for the route at the source node before any data for the route is sent from the node;
means for establishing a connection between the first node and the next node on the route and removing the reservation information for the two nodes and if
a) the first node is about to send the start marker to the next node,
b) the next node is not already connected to any upstream node, and
c) the reservation information of the next node indicates it should connect to the first node;
means for disconnecting a connection between the first node and the next node if
a) the next node has received an end of route marker from the first node, and
b) the next node is connected to the first node;
means for forwarding the end marker, start marker and data downstream over the connection;
means for transmitting data for each node to the next node connected on the route; and
means for creating and transmitting an end marker at a source node when subsequent data has to travel via another route.

10. A system according to claim 9, characterized in, that the step of reserving is done as one atomic action.

11. A system according to claim 9, characterized in that the reservation information is stored in the nodes on the route in an FIFO queue of a first input connection point (ICP) and in an FIFO queue of a second output connection point (OCP) where a number of node identifiers may be stored in each queue; each identifier representing a neighbouring node to which the node storing the reservation information should be connected to according to the reservation information in the queue.

12. A system according to claim 9, characterized in that said start marker precedes a stream of data and an end marker terminates a stream of data, where this ordering is maintained at all times.

13. A system according to claim 9, characterized in, that start and end markers are only inserted in a data stream if properties of the stream change.

14. A system according to claim 9, characterized in, that data in a stream may be buffered within a node.

15. A system according to claim 9, characterized in, that a route describes only a segment of the total list of nodes visited by a data stream.

16. A computer readable medium containing a program for making a processor carry out a method of dynamically routing of data through a processing network according to claim 1.
